(19) United States
(12) Patent Application Publication
(10) Pub. No.: US 2022/0128957 A1
(43) Pub. Date: Apr. 28, 2022

(54) DEVICE AND METHOD USING A NEURAL NETWORK TO DETECT AND COMPENSATE AN AIR VACUUM EFFECT

(71) Applicant: Distech Controls Inc., Brossard (CA)

(72) Inventor: Jean-Simon BOUCHER, Sainte-Julie (CA)

(21) Appl. No.: 17/082,443

(22) Filed: Oct. 28, 2020

(51) Int. Cl. G05B 19/042; G06N 3/08; G06N 5/04; G01J 1/02; G01K 13/00

(52) U.S. Cl. CPC G05B 19/042; G06N 3/08; G05B 2219/2642; G01J 1/02; G01K 13/00; G06N 5/04

(57) ABSTRACT

Device and method using a neural network to detect and compensate an air vacuum effect. The device stores a predictive model comprising weights of a neural network. The device receives an area temperature measurement (representative of a temperature of an area where the device is located) from a temperature sensing module of the device. The device determines at least one other measurement related to the device. The device executes a neural network inference engine implementing a neural network, using the predictive model for inferring output(s) based on inputs. The inputs comprise the area temperature measurement and the at least one other measurement related to the device. The output(s) comprises a metric representative of an air vacuum effect in the device. The device determines if an adjustment of the area temperature measurement needs to be performed based on the metric representative of the air vacuum effect in the device.

### TECHNICAL FIELD

The present disclosure relates to the field of building automation. More specifically, the present disclosure relates to a device and method using a neural network to detect and compensate an air vacuum effect.

### BACKGROUND

Systems for controlling environmental conditions, for example in buildings, are becoming increasingly sophisticated. An environment control system may at once control heating and cooling, monitor air quality, detect hazardous conditions such as fire, carbon monoxide release, intrusion, and the like. Such environment control systems generally include at least one environment controller, which receives measured environmental values (generally from external sensors), and in turn determines set-points or command parameters to be sent to controlled appliances.

Legacy equipment used in the context of the environmental control of room(s) of a building have evolved to support new functionalities. For instance, legacy thermostats only provided the functionality to allow a user to adjust the temperature in an area (e.g. in a room). Smart thermostats now also have the capability to read the temperature in the area and display it on a display of the smart thermostat. Furthermore, smart thermostats may have enhanced communication capabilities provided by a communication interface of the following type: Wi-Fi, Bluetooth®, Bluetooth® Low Energy (BLE), etc.

A smart thermostat with the capability to measure the temperature in the area where it is deployed includes a temperature sensing module for performing the temperature measurement. The smart thermostat also includes a processor for controlling the operations of the smart thermostat. The smart thermostat further includes the display for displaying the temperature measured by the temperature sensing module. Operations of the processor and the display dissipate heat, and the dissipated heat affects the temperature measured by the temperature sensing module. Thus, the temperature measured by the temperature sensing module of the smart thermostat may be inaccurate, for example when the processor is or has been operating recently (due to the heat dissipated by the processor which increases the temperature measured by the temperature sensing module). To mitigate the inaccuracy of the temperature measurement performed by the temperature sensing module, an adjustment is made to the measured temperature upon detection that one or more components (e.g. the processor and/or the display) of the smart thermostat is dissipating an amount of heat likely to affect the measurement performed by the temperature sensing module.

If an air vacuum effect occurs in the smart thermostat, ventilation of the air present in the smart thermostat is significantly increased, which compensates the aforementioned heat dissipation within the thermostat. Consequently, the aforementioned adjustment made to the measured temperature upon detection of a significant heat dissipation within the smart thermostat need to be cancelled (or at least limited) upon occurrence of an air vacuum effect in the smart thermostat.

For example, If the pressure in a room where the smart thermostat is located increases, some of the air present in the room attempts to leave the room for another room with a lower pressure. In particular, some of the air may circulate from the room where the smart thermostat is located to another room via the smart thermostat, creating an air vacuum effect in the smart thermostat. The air vacuum effect in the smart thermostat cools the air present in the smart thermostat that was previously heated because of the heat dissipation occurring inside the smart thermostat.

Therefore, there is a need for a device and method using a neural network to detect and compensate an air vacuum effect.

### SUMMARY

According to a first aspect, the present disclosure relates to a device. The device comprises memory for storing a predictive model comprising weights of a neural network. The device comprises a temperature sensing module adapted for measuring a temperature of an area where the device is located. The device comprises a processing unit comprising one or more processor. The processing unit is configured to receive an area temperature measurement from the temperature sensing module and determine at least one other measurement related to the device. The processing unit is further configured to execute a neural network inference engine. The neural network inference engine implements a neural network using the predictive model for inferring one or more output based on inputs. The inputs comprise the area temperature measurement and the at least one other measurement related to the device. The one or more output comprises a metric representative of an air vacuum effect in the device.

According to a second aspect, the present disclosure relates to a method using a neural network to detect and compensate an air vacuum effect. The method comprises storing a predictive model comprising weights of a neural network in a memory of a device. The method comprises receiving, by a processing unit of the device, an area temperature measurement from a temperature sensing module of the device, the area temperature measurement being representative of a temperature of an area where the device is located. The method comprises determining by the processing unit at least one other measurement related to the device. The method comprises executing by the processing unit a neural network inference engine. The neural network inference engine implements a neural network using the predictive model for inferring one or more output based on inputs. The inputs comprise the area temperature measurement and the at least one other measurement related to the device. The one or more output comprises a metric representative of an air vacuum effect in the device.

According to a third aspect, the present disclosure relates to a non-transitory computer program product comprising instructions executable by a processing unit of a device. The execution of the instructions by the processing unit provides for using a neural network to detect and compensate an air vacuum effect by implementing the aforementioned method.

In a particular aspect, the processing unit of the device determines if an adjustment of the area temperature measurement needs to be performed based on the metric representative of the air vacuum effect in the device.

In another particular aspect, the device is a smart thermostat.

### BRIEF DESCRIPTION OF THE DRAWINGS

Embodiments of the disclosure will be described by way of example only with reference to the accompanying drawings, in which:

FIGS. 1A and 1B illustrate an environment control system comprising a smart thermostat embedding a temperature sensing module;

FIGS. 2A, 2B, 2C and 2D illustrate various implementations of components of the smart thermostat represented in FIGS. 1A and 1B;

FIG. 3 illustrates the influence of CPU utilization on the temperature measured by the temperature sensing module of the smart thermostat represented in FIGS. 1A and 1B;

FIGS. 4A and 4B illustrate a method using a neural network to detect and compensate an air vacuum effect occurring in the smart thermostat represented in FIGS. 1A and 1B;

FIGS. 5A is a schematic representation of a neural network inference engine executed by the smart thermostat represented in FIGS. 1A and 1B according to the method of FIGS. 4A and 4B;

FIGS. 5B, 5C and 5D are exemplary representations of a neural network implemented by the neural network inference engine represented in FIG. 5A; and

FIG. 6 illustrates an environment control system where several smart thermostats implementing the method illustrated in FIGS. 4A and 4B are deployed.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to environment control systems for buildings. More particularly, the present disclosure aims at providing solutions for improving the accuracy of the measurement of a temperature in an area of a building, performed by a temperature sensing module integrated to a smart thermostat (or another device). An adjustment of the temperature measured by the temperature sensing module is performed when needed, to compensate for an error on the temperature measurement due to heat generated by other electronic components of the smart thermostat, such as a processor and a Liquid Crystal Display (LCD). Detection of an air vacuum effect occurring in the smart thermostat is performed, to cancel or at least minimize the adjustment of the temperature measurement when the air vacuum effect is detected.

The following terminology is used throughout the present specification:

Environment: condition(s) (temperature, pressure, oxygen level, light level, security, etc.) prevailing in a controlled area or place, such as for example in a building.

Environment control system: a set of components which collaborate for monitoring and controlling an environment.

Environmental data: any data (e.g. information, commands) related to an environment that may be exchanged between components of an environment control system.

Environment control device (ECD): generic name for a component of an environment control system. An ECD may consist of an environment controller, a sensor, a controlled appliance, etc.

Environment controller: device capable of receiving information related to an environment and sending commands based on such information.

Environmental characteristic: measurable, quantifiable or verifiable property of an environment (a building). The environmental characteristic comprises any of the following: temperature, pressure, humidity, lighting, CO2, flow, radiation, water level, speed, sound; a variation of at least one of the following, temperature, pressure, humidity and lighting, CO2 levels, flows, radiations, water levels, speed, sound levels, etc., and/or a combination thereof.

Environmental characteristic value: numerical, qualitative or verifiable representation of an environmental characteristic.

Sensor: device that detects an environmental characteristic and provides a numerical, quantitative or verifiable representation thereof. The numerical, quantitative or verifiable representation may be sent to an environment controller.

Controlled appliance: device that receives a command and executes the command. The command may be received from an environment controller.

Environmental state: a current condition of an environment based on an environmental characteristic, each environmental state may comprise a range of values or verifiable representation for the corresponding environmental characteristic.

VAV appliance: a Variable Air Volume appliance is a type of heating, ventilating, and/or air-conditioning (HVAC) system. By contrast to a Constant Air Volume (CAV) appliance, which supplies a constant airflow at a variable temperature, a VAV appliance varies the airflow at a constant temperature.

Area of a building: the expression ‘area of a building’ is used throughout the present specification to refer to the interior of a whole building or a portion of the interior of the building such as, without limitation: a floor, a room, an aisle, etc.

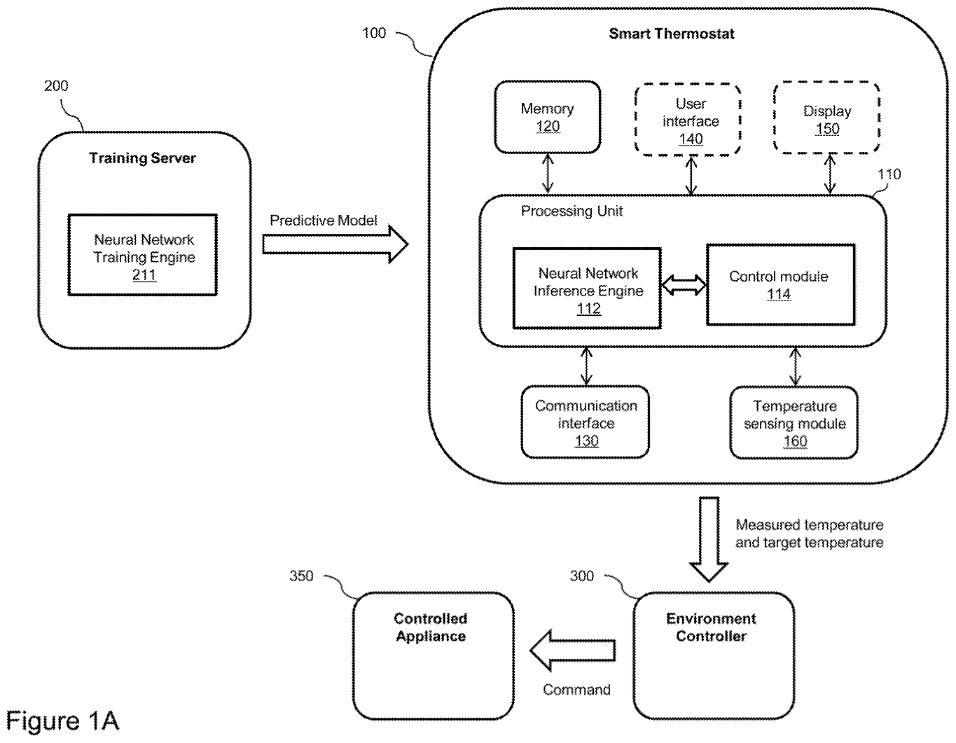

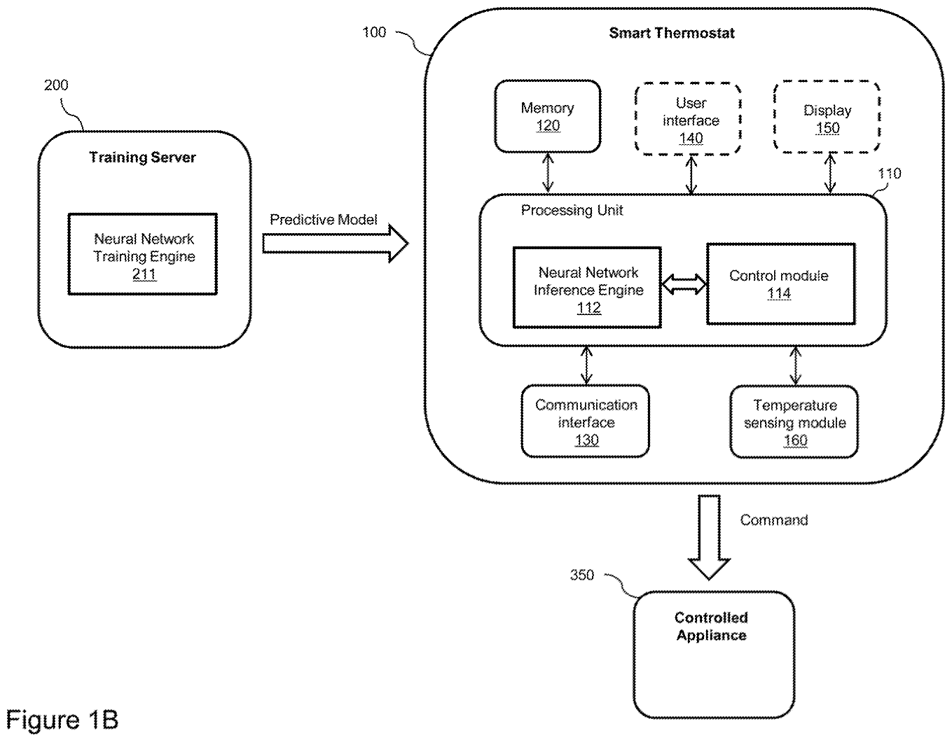

Reference is now made concurrently to FIGS. 1A and 1B, which represent an environment control system where a device 100 is deployed. The device 100 monitors and/or adjusts environmental conditions of an area where it is deployed. For example, the device 100 is a smart thermostat. The smart thermostat 100 controls the temperature in the area, either directly through interactions with a controlled appliance 350 (FIG. 1B) or indirectly through interactions with an environment controller 300 (FIG. 1A).

The device 100 is not limited to a smart thermostat. Other types of devices with the characteristics and functionalities that will be described in the rest of the disclosure may implement the device 100.

The area under the control of the device 100 is not represented in FIGS. 1A and 1B for simplification purposes. As mentioned previously, the area may consist of a room, a floor, an aisle, etc. However, any type of area located inside any type of building is considered to be within the scope of the present disclosure.

Details of the device 100, environment controller 300 and control appliance 350 will now be provided.

The device 100 comprises a processing unit 110, memory 120, a communication interface 130, a user interface 140, a display 150, and a temperature sensing module 160. The device 100 may comprise additional components not represented in FIGS. 1A and 1B. The user interface 140 and the display 150 are respectively optional, and may not be included in the device 100.

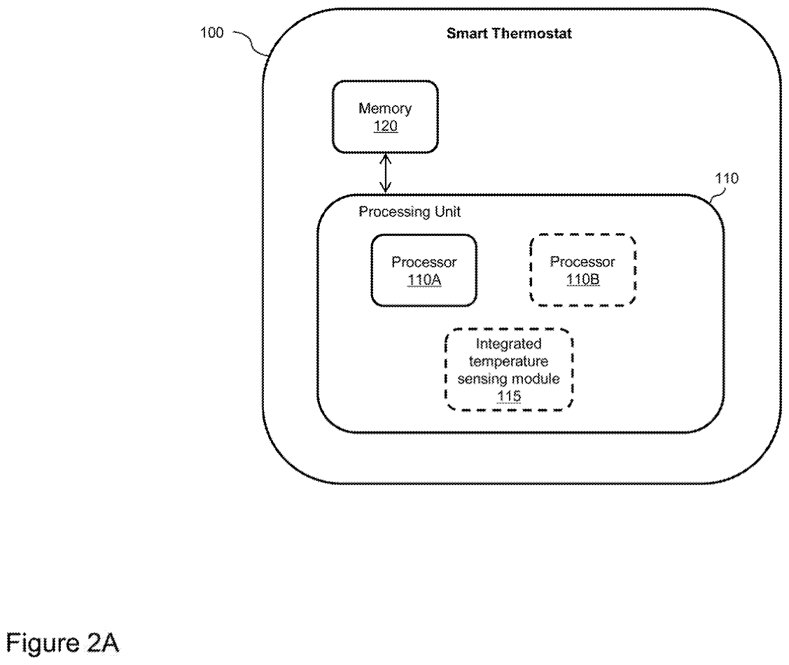

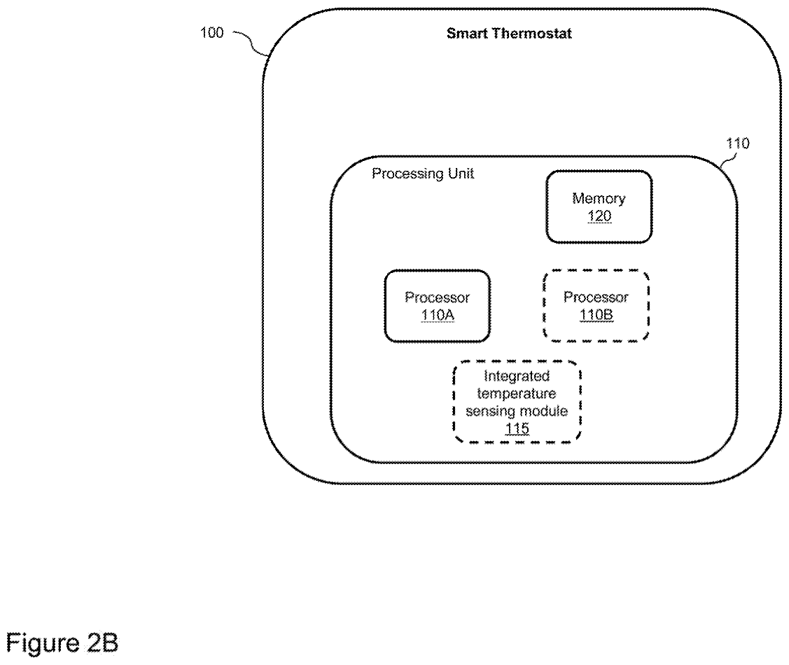

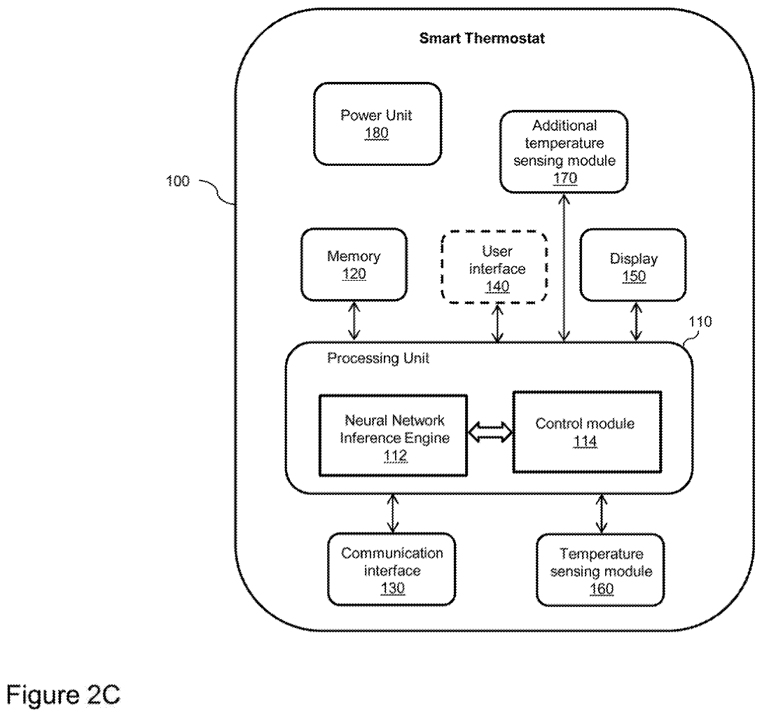

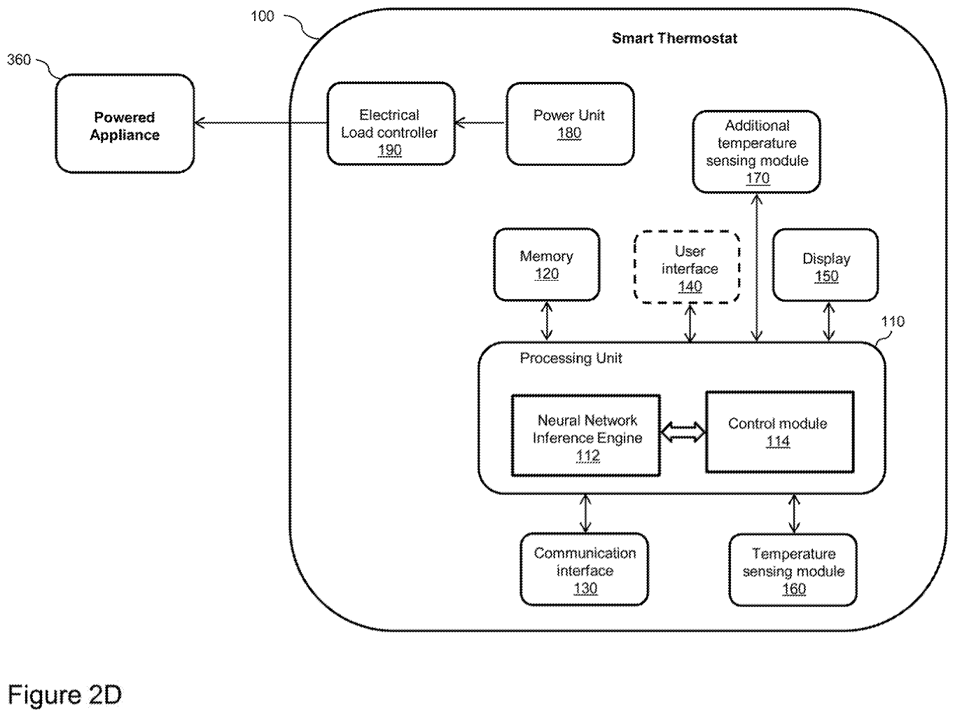

The processing unit 110 comprises one or more processor (represented in FIGS. 2A and 2B) capable of executing instructions of a computer program. Each processor may further comprise one or several cores. The processing unit 110 executes a neural network inference engine 112 and a control module 114, as will be detailed later in the description.

The memory 120 stores instructions of computer program(s) executed by the processing unit 110, data generated by the execution of the computer program(s), data received via the communication interface 130, etc. Only a single memory 120 is represented in FIGS. 1A and 1B, but the device 100 may comprise several types of memories, including volatile memory (such as a volatile Random Access Memory (RAM), etc.) and non-volatile memory (such as an electrically-erasable programmable read-only memory (EEPROM), flash, etc.).

The communication interface 130 allows the device 100 to exchange data with remote devices (e.g. the environment controller 300, the controlled appliance 350, a training server 200, etc.) over a communication network (not represented in FIGS. 1A and 1B for simplification purposes). For example, the communication network is a wired communication network, such as an Ethernet network; and the communication interface 130 is adapted to support communication protocols used to exchange data over the Ethernet network. Other types of wired communication networks may also be supported by the communication interface 130. In another example, the communication network is a wireless communication network, such as a Wi-Fi network; and the communication interface 130 is adapted to support communication protocols used to exchange data over the Wi-Fi network. Other types of wireless communication network may also be supported by the communication interface 130, such as a wireless mesh network, Bluetooth®, Bluetooth® Low Energy (BLE), cellular (e.g. a 4G or 5G cellular network), etc. Optionally, the device 100 comprises more than one communication interface 130, and each one of the communication interfaces 130 is dedicated to the exchange of data with specific type(s) of device(s).

The user interface 140 may take various forms. In a first exemplary implementation, the user interface 140 is an electromechanical user interface comprising a button for raising the temperature in the area and a button for decreasing the temperature in the area. A pressure on one of the two buttons is transformed into an electrical signal transmitted to the processing unit 110. In a second exemplary implementation, the user interface 140 is a tactile user interface integrated to the display 150. As mentioned previously, the user interface 140 is optional.

The display 150 is a small size display integrated to the device, such as a Liquid Crystal Display (LCD). As mentioned previously, the display 150 is optional.

The temperature sensing module 160 is a component well known in the art of environmental control. It is capable of measuring a temperature and transmitting the measured temperature to the processing unit 110. The temperature measured by the temperature sensing module 160 is considered as being representative of the temperature in the area (e.g. in the room) where the device 100 is deployed. The details of the implementation of a device comprising a temperature sensing module capable of measuring a temperature representative of the temperature in the area where the device is deployed are well known in the art, and out of the scope of the present disclosure.

As mentioned previously, FIG. 1A illustrates a configuration where the device 100 interacts with the environment controller 300. A temperature is measured by the temperature sensing module 160 and transmitted to the environment controller 300 via the communication interface 130. A user interaction for modifying the temperature in the area is detected via the user interface 140 and a corresponding target temperature is transmitted to the environment controller 300 via the communication interface 130. The processing unit 110 generates the corresponding target temperature based on the detected user interaction. The environment controller 300 uses the measured temperature and the target temperature received from the device 100 to control at least one controlled appliance 350. FIG. 1A represents the environment controller 300 sending a command to a controlled appliance 350 (e.g. an electrical heater, a VAV), the command being generated based on the received measured temperature and target temperature (and possibly additional parameters).

As mentioned previously, FIG. 1B illustrates a configuration where the device 100 directly controls a controlled appliance 350 (e.g. an electrical heater, a VAV). A temperature is measured by the temperature sensing module 160. A user interaction for modifying the temperature in the area is detected via the user interface 140. A corresponding target temperature is generated by the processing unit 110 based on the detected user interaction. The processing unit uses the measured temperature and the target temperature to generate a command, which is sent to the controlled appliance 350 via the communication interface 130.

The temperature measured by the temperature sensing module 160 is also displayed on the display 150, so that a user can be informed of the current temperature (the measured temperature) in the area.

A detailed representation of the components of the environment controller 300 is not provided in FIG. 1A for simplification purposes. The environment controller 300 comprises a processing unit, memory and at least one communication interface. The processing unit of the environment controller 300 processes environmental data received from one or more apparatus (e.g. from the device 100, from sensors not represented in FIG. 1A, etc.) and generates commands for controlling appliances (e.g. 350) based on the received data. The environmental data and commands are respectively received and transmitted via the at least one communication interface.

A detailed representation of the components of the controlled appliance 350 is not provided in FIGS. 1A and 1B for simplification purposes. The controlled appliance 350 comprises at least one actuation module, to control operations of the controlled appliance 350 based on received commands. The actuation module can be of one of the following type: mechanical, pneumatic, hydraulic, electrical, electronical, a combination thereof, etc. The controlled appliance 350 further comprises a communication interface for receiving the commands from the environment controller 300 (FIG. 1A) or from the device 100 (FIG. 1B). The controlled appliance 350 may also comprise a processing unit for controlling the operations of the at least one actuation module based on the received one or more command.

An example of a controlled appliance 350 consists of a VAV appliance. Examples of commands transmitted to the VAV appliance include commands directed to one of the following: an actuation module controlling the speed of a fan, an actuation module controlling the pressure generated by a compressor, an actuation module controlling a valve defining the rate of an airflow, etc. This example is for illustration purposes only. Other types of controlled appliances 350 could be used in the context of interactions with the environment controller 300 or with the device 100.

A detailed representation of the components of the training server 200 is not provided in FIGS. 1A and 1B for simplification purposes. The training server 200 comprises a processing unit, memory and a communication interface. The processing unit of the training server 200 executes a neural network training engine 211. The execution of the neural network training engine 211 generates a predictive model, which is transmitted to the device 100 via the communication interface of the training server 200. The predictive model is transmitted over a communication network and received via the communication interface 130 of the device 100.

Reference is now made concurrently to FIGS. 1A, 1B, 2A and 2B. FIGS. 2A and 2B only represent the processing unit 110 and the memory 120 of the device 100 represented in FIGS. 1A and 1B. The other components of the device 100 have been omitted in FIGS. 2A and 2B for simplification purposes.

As mentioned previously, the processing unit 110 may include one or more processor. For example, the processing unit 110 includes a single processor 110A, which executes the neural network inference engine 112 and the control module 114. In another example, the processing unit 110 includes a first processor 110A which executes the neural network inference engine 112 and a second processor 110B which executes the control module 114. Furthermore, FIG. 2A illustrates a configuration where the memory 120 is not integrated to the processing unit 110, while FIG. 2B illustrates a configuration where the memory 120 is integrated to the processing unit 110. The processing unit 110 represented in FIG. 2B is generally referred to as a micro-controller, and may include additional component(s) of the device 100, such as the communication interface 130. The term processor shall be interpreted broadly as including any electronic component capable of executing instructions of a software program stored in the memory 120.

Optionally, the processing unit 110 comprises an integrated temperature sensing module 115 for measuring a temperature of the processing unit 110. If the processing unit 110 comprises a single processor 110A, the integrated temperature sensing module 115 measures a temperature which varies based on an amount of heat generated by the processor 110A. More specifically, the temperature measured by temperature sensing module 115 increases when the percentage of utilization of the processor 110A increases (from 0% when the processor 110A is idle to 100% when the processor 110A operates at full capacity). The temperature measured by the integrated temperature sensing module 115 is transmitted (internally to the processing unit 110) to the processor 110A, for further processing by a software program executed by the processor 110A.

If the processing unit 110 comprises several processors (e.g. 110A and 110B), the integrated temperature sensing module 115 measures a temperature which varies based on an amount of heat generated collectively by all the processors (e.g. 110A and 110B). In an alternative design, the processing unit 110 includes several integrated temperature sensing modules 115, each one of the integrated temperature sensing modules 115 being dedicated to one of the processors (e.g. an integrated temperature sensing module 115 dedicated to the processor 110A and another integrated temperature sensing module 115 dedicated to the processor 110B). The configuration with several integrated temperature sensing modules 115 is not represented in the Figures for simplification purposes.

Reference is now made concurrently to FIGS. 1A, 1B and 2C. FIG. 2C represents the device 100 of FIGS. 1A and 1B, comprising an additional temperature sensing module 170.

The temperature measured by the additional temperature sensing module 170 is considered as being representative of an internal temperature of the device 100, and is mainly influenced by one or more component of the device 100 which generates a significant amount of heat. The additional temperature sensing module 170 measures the internal temperature of the device 100 and transmits the measured temperature to the processing unit 110. A significant amount of heat is an amount of heat with the potential to disturb the measurement performed by the temperature sensing module 160 beyond an acceptable threshold.

The terminology internal temperature measurement (representative of a temperature inside the device 100 subject to heat generation inside the device 100) is used in contrast to the temperature measurement performed by the temperature sensing module 160 (representative of a temperature in the area where the device 100 is located).

As illustrated in FIG. 2C, the device 100 also includes a power unit 180 for powering several components of the device 100 (e.g. for powering the processing unit 110, the communication interface 130, the display 150, etc.). For simplification purposes, electrical circuits transmitting power from the power unit 180 to several components of the device 100 are not represented in FIG. 2C.

At least one of the following components of the device 100 generates an amount of heat that significantly influences the internal temperature measured by the additional temperature sensing module 170: the display 150, the power unit 180, the communication interface 130, etc. It is well known in the art that during its operations, the display 150 (e.g. an LCD display) or the power unit 180 dissipates heat. In the case of a communication interface 130 consisting of a Wi-Fi module, it is also well known in the art that the Wi-Fi module operates according to different modes of communication. Some of the modes of communication require more power for transmitting data over the air, which in turn generates more heat within the device 100.

The location of the additional temperature sensing module 170 in the device 100 is determined so that the measured internal temperature properly accounts for the heat generated by some of the components of the device 100. For example, the additional temperature sensing module 170 is located in close vicinity of the component (or the components) which has (have) the greatest contribution(s) to the generation of heat in the device 100. For illustration purposes only, in FIG. 2C, the additional temperature sensing module 170 is close to the display 150 and the power unit 180, because they have the two greatest contributions to the generation of heat in the device 100.

When the processing unit 110 comprises the integrated temperature sensing module 115 represented in FIGS. 2A and 2B, the additional temperature sensing module 170 may also account for the heat generated by the processing unit 110 (in addition to the integrated temperature sensing module 115).

In another implementation (not represented in the Figures for simplification purposes), the device 100 comprises more than one additional temperature sensing module 170. Each additional temperature sensing module 170 is located in close vicinity of at least one corresponding component of the device 100, to respectively measure an internal temperature that properly accounts for the heat generated by the at least one corresponding component of the device 100.

For example (as mentioned previously), the additional temperature sensing module 170 represented in FIG. 2C measures a first internal temperature representative of the heat generated by the display 150 and the power unit 180. A second additional temperature sensing module 170 (not represented in FIG. 2C for simplification purposes) is located in close vicinity of the processing unit 110 and the communication interface 130, to measure a second internal temperature representative of the heat generated by the processing unit 110 and the communication interface 130.

Different types of temperature sensors may be used for implementing the temperature sensing module 160 and the additional temperature sensing module 170. For example, the temperature sensing module 160 is more sophisticated, to provide a precise temperature measurement. The additional temperature sensing module 170 is less sophisticated, to provide an approximative temperature measurement. Additionally, the temperature sensing module 160 is preferably located at a position distant from the components of the device 100 which generate heat. By contrast, the additional temperature sensing module 170 is preferably located at a position close to at least one component of the device 100 which generates heat.

Reference is now made concurrently to FIGS. 2C and 2D. FIG. 2D represents the device 100 of FIG. 2C, comprising an electrical load controller 190. The electrical load controller 190 transmits an electrical current to a powered appliance 360. For example, the powered appliance 360 is a ventilator comprising a motor for actuating a fan. A rotation speed of the fan depends on the amount of electrical current provided to the motor by the electrical load controller 190. The electrical current is provided by the power unit 180, which is electrically connected to the electrical load controller 190. The processing unit 110 executes an algorithm that controls the electrical load controller 190, to determine which amount of electrical current is provided by the power unit 180 and transmitted to the motor by the electrical load controller 190. The electrical load controller 190 also contributes to the heat dissipation in the device 100. More specifically, the amount of heat dissipated by the electrical load controller 190 increases with the amount of electrical current transmitted by the electrical load controller 190 to the powered appliance 360.

At least one among the one or more additional temperature sensing module 170 measures an internal temperature that is representative of the amount of heat generated by the electrical load controller 190.

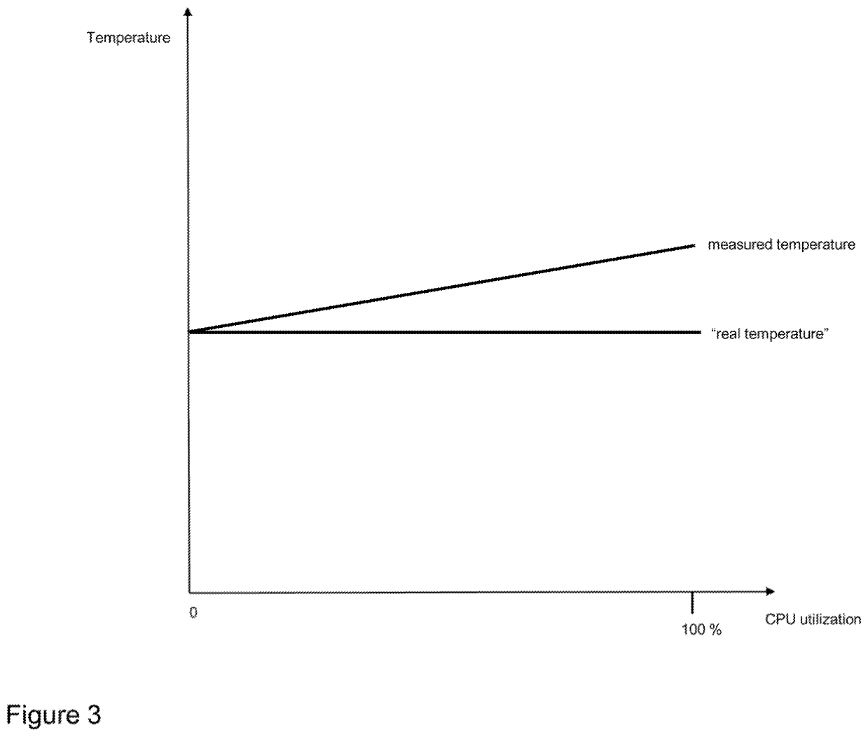

Reference is now made concurrently to FIGS. 1A, 1B, 2A, 2B, 2C, 2D and 3. FIG. 3 represents a curve illustrating the influence of Central Processing Unit (CPU) utilization on the temperature measured by the temperature sensing module 160. CPU utilization is a terminology well known in the art of computing, and represents the utilization (expressed in percentage) of a processor (e.g. 110A) of the processing unit 110. Heat dissipated by the processor (e.g. 110A) increases with CPU utilization, and impacts the temperature measured by the temperature sensing module 160. FIG. 3 represents the “real temperature” in the area where the device 100 is deployed, and the temperature measured by the temperature sensing module 160. At low CPU utilization, the measured temperature is a good approximation of the real temperature in the area. However, as CPU utilization increases, the measured temperature is no longer a good approximation of the real temperature in the area. For simplification purposes, FIG. 3 illustrates a correlation where the measured temperature increases linearly with the CPU utilization. However, the relationship between the measured temperature and the CPU utilization is a more complex one, which is out of the scope of the present disclosure.

A similar curve may be represented, illustrating the influence of the utilization of the display 150 (or the power unit 180, the communication interface 130, the electrical load controller 190, etc.) on the temperature measured by the temperature sensing module 160. An increase in the utilization of the display 150 (or the power unit 180, the communication interface 130, the electrical load controller 190, etc.) generates more heat, which increases the deviation of the measured temperature from the real temperature.

In order to compensate for the difference between the real temperature in the area and temperature measured by temperature sensing module 160, the processing unit 110 executes an adjustment algorithm. The adjustment algorithm calculates an adjusted temperature, based on the temperature measured by the temperature sensing module 160 and parameter(s) representative of the heat generated by one or more component of the device 100 (e.g. heat generated by the processing unit 110, the display 150, the power unit 180, the communication interface 130, the electrical load controller 190, etc.). The adjusted temperature is a more accurate evaluation of the real temperature in the area than the temperature measured by the temperature sensing module 160.

Following is an example of how the adjustment algorithm operates. This example is for illustration purposes only and has been simplified. The implementation of the adjustment algorithm is out of the scope of the present disclosure.

In a first exemplary situation, the real temperature in the area is 24 degrees Celsius. The only processor 110A of the processing unit 110 is operating at 25% capacity and the integrated temperature sensing module 115 measures a temperature of the processing unit 110 equal to 30 degrees Celsius. The heat generated by the processing unit 110 does not affect the temperature sensing module 160, which measures an area temperature of 24 degrees Celsius. The adjustment algorithm takes into consideration the area temperature measured by the temperature sensing module 160 and the temperature of the processing unit 110, and determines that no adjustment of the area temperature measured by the temperature sensing module 160 is needed. Actually, the area temperature measured by the temperature sensing module 160 is effectively equal to the real temperature in the area.

In a second exemplary situation, the real temperature in the area is still 24 degrees Celsius. The only processor 110A of the processing unit 110 is now operating at 85% capacity and the integrated temperature sensing module 115 measures a temperature of the processing unit 110 equal to 50 degrees Celsius. The heat generated by the processing unit 110 affects the temperature sensing module 160, which measures an area temperature of 26 degrees Celsius. The adjustment algorithm takes into consideration the area temperature measured by the temperature sensing module 160 and the temperature of the processing unit 110, and determines that an adjustment of the area temperature measured by the temperature sensing module 160 is needed, the adjustment being equal to 2 degrees Celsius. Actually, the area temperature measured by the temperature sensing module 160 is effectively 2 degrees Celsius higher than the real temperature in the area. The adjustment determined by the adjustment algorithm accurately compensates the difference between the area temperature measured by the temperature sensing module 160 and the real temperature in the area.

Following is a description of the impact of an air vacuum effect in the device 100. The air vacuum effect occurs when a ventilation of the air inside the device 100 is beyond a usual ventilation standard. For example, the air vacuum effect occurs when an increase in the ventilation of the air inside the device 100 is caused by a differential pressure. For instance, the area where the device 100 is located is a given room, which is closed. An air duct pushes air in the given room, causing an increase of the air pressure in the given room by comparison to the air pressure in rooms adjacent to the given room. In this case, the air present in the given room will tend to exit the given room towards the adjacent rooms, in order to balance the air pressure in the given room and the adjacent rooms. To exit the given room, the air goes through any available opening(s) in the walls, ceiling, floor, etc. of the given room. In particular, in a configuration where there is an opening in the wall behind the device 100 and a corresponding opening in the device 100 (for example to allow a connection of wires located in the wall to internal components of the device, such as the power unit 180 represented in FIG. 2C), the air inside the device 100 is vacuumed by the opening in the wall to which it is affixed.

In the previously mentioned fist exemplary situation, the air vacuum effect has not impact on the measurement performed by the temperature sensing module 160. This is due to the fact that the area temperature measured by the temperature sensing module 160 is equal to the real temperature in the area (24 degrees Celsius).

In the previously mentioned second exemplary situation, the air vacuum effect has an impact on the measurement performed by the temperature sensing module 160. This is due to the fact that without the air vacuum effect, the area temperature measured by the temperature sensing module 160 is different from the real temperature in the area (26 instead of 24 degrees Celsius due to internal heating of the device 100). However, the air vacuum effect reduces the temperature inside the device 100, by replacing hotter air within the device 100 by fresher air from the area where the device 100 is located. In case of a strong vacuum effect, the area temperature measured by the temperature sensing module 160 is 24 degrees Celsius and there is no need of applying the 2 degrees Celsius adjustment determined by the adjustment algorithm. In case of a medium vacuum effect, the area temperature measured by the temperature sensing module 160 is 25 degrees Celsius and an adjustment of 1 degree Celsius need to be applied, instead of the 2 degrees Celsius adjustment determined by the adjustment algorithm. In case of no medium vacuum effect, the area temperature measured by the temperature sensing module 160 is 26 degrees Celsius and the 2 degrees Celsius adjustment determined by the adjustment algorithm need to be applied.

The present disclosure aims at determining if an air vacuum effect is occurring inside the device 100, to adapt the temperature adjustment determined by the adjustment algorithm to the existence and intensity of the air vacuum effect. A plurality of operating parameters of the device 100 are used for determining if an air vacuum effect is occurring inside the device 100. This plurality of operating parameters of the device 100 will be detailed later in the description.

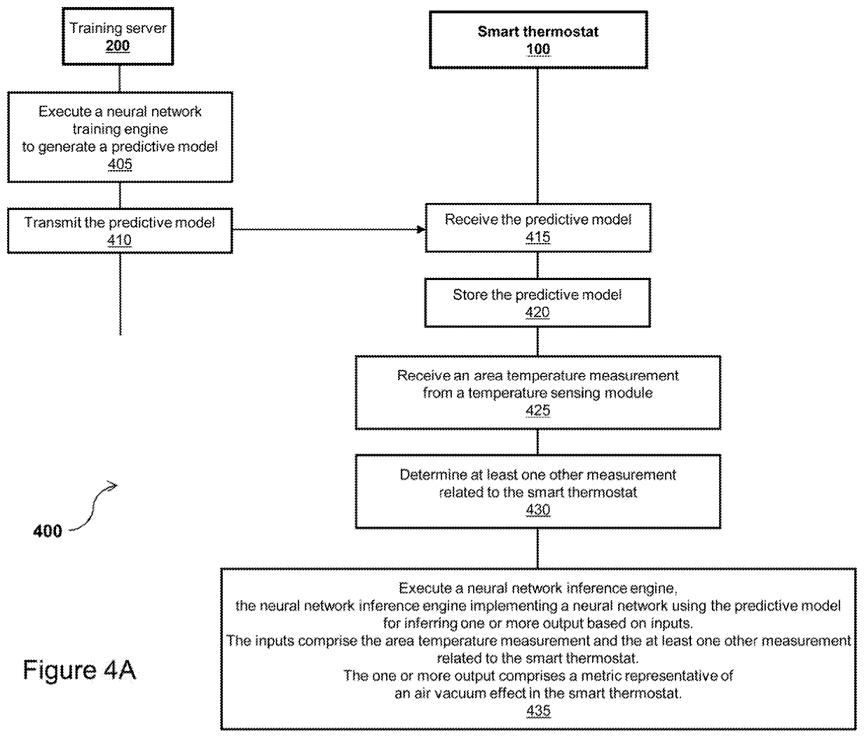

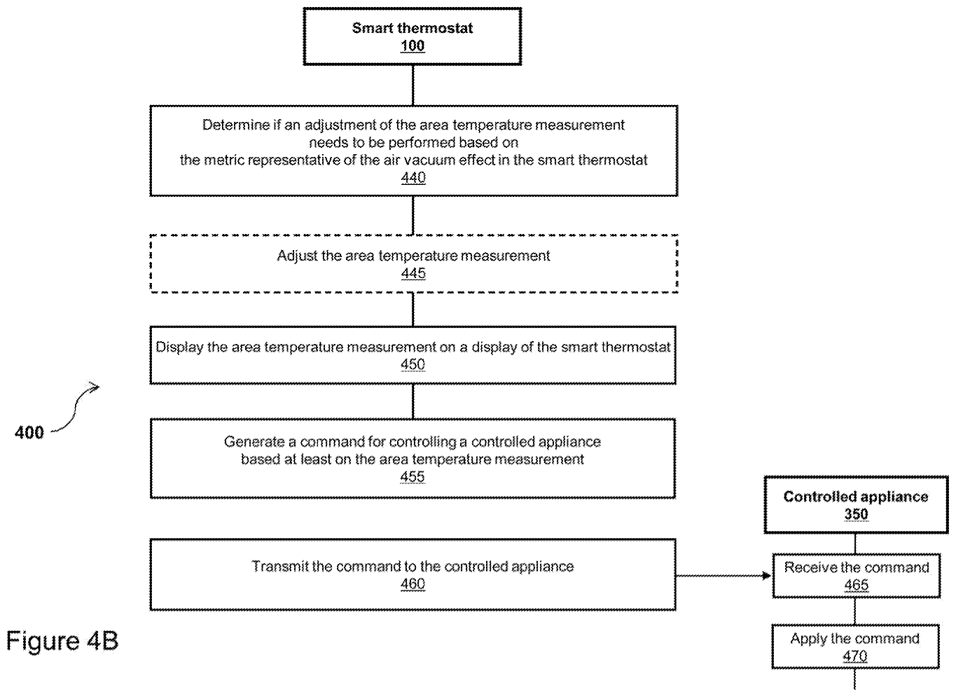

Reference is now made concurrently to FIGS. 1A, 1B, 2A, 2B, 2C, 2D, 4A and 4B. FIGS. 4A and 4B illustrate a method 400 using a neural network to detect and compensate an air vacuum effect. At least some of the steps of the method 400 are implemented by the device 100. As mentioned previously, an example of device 100 consists of a smart thermostat. However, the present disclosure is not limited to a smart thermostat, but is applicable to any type of device 100 capable of implementing the steps of the method 400.

A dedicated computer program has instructions for implementing at least some of the steps of the method 400. The instructions are comprised in a non-transitory computer program product (e.g. the memory 120) of the device 100. The instructions provide for using a neural network to detect and compensate an air vacuum effect, when executed by the processing unit 110 of the device 100. The instructions are deliverable to the device 100 via an electronically-readable media such as a storage media (e.g. USB key, etc.), or via communication links (e.g. via a communication network through the communication interface 130).

The instructions of the dedicated computer program executed by the processing unit 110 implement the neural network inference engine 112 and the control module 114. The neural network inference engine 112 provides functionalities of a neural network, allowing to infer output(s) based on inputs using the predictive model stored in the memory 120, as is well known in the art. The control module 114 provides functionalities for controlling the components of the device 100 and for allowing the device 100 to interact with and/or control other devices (e.g. the environment controller 300 or the controlled appliance 350).

The method 400 comprises the step 405 of executing the neural network training engine 211 to generate the predictive model. Step 405 is performed by the processing unit of the training server 200. This step will be further detailed later in the description.

The method 400 comprises the step 410 of transmitting the predictive model generated at step 405 to the device 100, via the communication interface of the training server 200. Step 410 is performed by the processing unit of the training server 200.

The method 400 comprises the step 415 of receiving the predictive model from the training server 200, via the communication interface 130 of the device 100. Step 415 is performed by the control module 114 executed by the processing unit 110.

The method 400 comprises the step 420 of storing the predictive model in the memory 120 of the device 100. Step 420 is performed by the control module 114 executed by the processing unit 110.

The method 400 comprises the step 425 of receiving a temperature measurement from the temperature sensing module 160. Step 425 is performed by the control module 114 executed by the processing unit 110. As mentioned previously, the measurement of a temperature by a temperature sensing module (e.g. 160) is well known in the art. In the rest of the disclosure, the temperature measurement performed by the temperature sensing module 160 will be referred to as the area temperature measurement, since it is aimed at being representative of the temperature in the area where the device 100 is located.

The method 400 comprises the step 430 of determining at least one other measurement related to the device 100. Step 430 is performed by the control module 114 executed by the processing unit 110. The determination of the at least one other measurement related to the device 100 is performed internally by the processing unit 110 or received by the processing unit 110 from another component of the device 100.

At least one among the other measurement(s) is related to one of the following components of the device 100: the processing unit 110, the display 150, the communication interface 130, the power unit 180 and the electrical load controller 190. One of the other measurements may be related to another component of the device 100 (which may not be represented in FIGS. 1A and 1B) generating a significant amount of heat during its operations.

For example, the at least one other measurement consists of a single measurement related to the processing unit 110. In another example, the at least one other measurement consists of one measurement related to the processing unit 110 and one measurement related to the display 150. In still another example, the at least one other measurement consists of one measurement related to the processing unit 110 and one measurement related to the communication interface 130. In yet another example, the at least one other measurement consists of one measurement related to the processing unit 110, one measurement related to the display 150 and one measurement related to the communication interface 130.

With respect to a measurement related to the processing unit 110, an exemplary measurement is the temperature measurement of the processing unit 110 performed by the integrated temperature sensing module 115 represented in FIGS. 2A and 2B. Alternatively, a temperature measurement related to the processing unit 110 is an internal temperature of the device 100 performed by one of the additional temperature sensing module(s) 170 (located in close vicinity of the processing unit 110, but not integrated to the processing unit 110 like the integrated temperature sensing module 115).

Another exemplary measurement is a utilization metric of the one or more processor (e.g. only processor 110A as illustrated in FIG. 2A, or processors 110A and 110B as illustrated in FIG. 2B) of the processing unit 110. As mentioned previously, a commonly used utilization metric of a processor is the CPU utilization of the processor, which can be represented as a percentage varying from 0 to 100%. In the case of a single processor 110A, the utilization metric for the processing unit 110 is the CPU utilization of the processor 110A. In the case of several processors (e.g. 110A and 110B), the utilization metric for the processing unit 110 is calculated based on the CPU utilizations of each one of the several processors. Following is a first exemplary implementation in the case of the two processors 110A and 1106. The utilization metric for the processing unit 110 is the average of the CPU utilization of the processor 110A and the CPU utilization of the processor 1106. For example, the CPU utilization of the processor 110A is 20% and the CPU utilization of the processor 1106 is 80%, then the utilization metric for the processing unit 110 is (20%+80%)/2=50%. Following is a second exemplary implementation in the case of the two processors 110A and 1106. The utilization metric for the processing unit 110 is a weighted average of the CPU utilization of the processor 110A and the CPU utilization of the processor 1106. For example, the CPU utilization of the processor 110A is 20% with a weight of 1 and the CPU utilization of the processor 1106 is 80% with a weight of 2, then the utilization metric for the processing unit 110 is (20%*1+80%*2)/3=60%. The utilization of a weighted average allows to take into account the specific individual contributions of the processors to the heating of the device 100 (a more powerful processor contributes more than a less powerful processor to the heating for the same value of the CPU utilization).

A person skilled in the art would readily understand that the utilization metric of processor(s) of the processing unit 110 may be calculated in a different way, as long as the utilization metric is representative of the contribution of the processor(s) of the processing unit 110 to the heating of the device 100.

With respect to a measurement related to the display 150, an exemplary measurement is an internal temperature measurement of the device 100 performed by one of the additional temperature sensing module(s) 170 (located in close vicinity of the display 150).

Another exemplary measurement is a utilization metric of the display 150. An exemplary utilization metric of the display 150 is a percentage of utilization of the display varying from 0 to 100%, and representative of a dimming level or light intensity output of the display 150. For example, the percentage of utilization is based on a pulse-width-modulation (PWM) voltage used for controlling the dimming level or light intensity output of the display 150. If the current PWM voltage is V and the maximum PWM voltage is Vₘₐₓ then the utilization metric of the display 150 is V/Vₘₐₓ*100%. Alternatively, the utilization metric of the display 150 is representative of a backlight level of the display 150. The dimming level, light intensity output and backlight level are all directly related to a power consumption of the display 150, the power consumption being itself related to a generation of heat by the display 150.

Another exemplary utilization metric of the display 150 is a measurement of the illumination in the area expressed in lux. In this case, the device 100 includes an illumination sensor (not represented in the Figures for simplification purposes) capable of measuring the illumination in the area. The illumination sensor is used to adjust the backlight of the display 150. The backlight is decreased (producing less heat) if the measured illumination decreases and the backlight is increased (producing more heat) if the measured illumination increases (above a certain level of measured illumination, the backlight is always set to 100%).

A person skilled in the art would readily understand that the utilization metric of the display 150 may be calculated in a different way, as long as the utilization metric is representative of the contribution of the display 150 to the heating of the device 100.

With respect to a measurement related to the communication interface 130, an exemplary measurement is an internal temperature measurement of the device 100 performed by one of the additional temperature sensing module(s) 170 (located in close vicinity of the communication interface 130).

Another exemplary measurement is a utilization metric of the communication interface 130. For example, the utilization metric is calculated based on a current transmission rate and/or a current reception rate of the communication interface 130 (e.g. a current percentage of utilization of the communication interface 130 for transmitting and/or receiving data expressed as a percentage of the maximum available capacity).

A person skilled in the art would readily understand that the utilization metric of the communication interface 130 may be calculated in a different way, as long as the utilization metric is representative of the contribution of the communication interface 130 to the heating of the device 100.

With respect to a measurement related to the power unit 180, an exemplary measurement is an internal temperature measurement of the device 100 performed by one of the additional temperature sensing module(s) 170 (located in close vicinity of the power unit 180).

Another exemplary measurement is a utilization metric of the power unit 180, which can be represented as a percentage varying from 0 to 100%. For instance, the utilization metric is a percentage representing the relative electrical power currently provided by the power unit 180 to components of the device 100 (e.g. to the processing unit 110, to the display 150, etc.). For example, if the maximum electrical power is 5 Watts and the electrical power currently provided is 2 W, then the utilization metric is 40%. This utilization metric is available only if the power unit 180 implements the functionality to read in real time (by the processing unit 110) the electrical power (or directly the percentage of the maximum electrical power) provided to the components of the device 100.

With respect to a measurement related to the electrical load controller 190, an exemplary measurement is an internal temperature measurement of the device 100 performed by one of the additional temperature sensing module(s) 170 (located in close vicinity of the electrical load controller 190).

As mentioned previously, each additional temperature sensing module 170 measures an internal temperature of the device 100 that is representative of the contribution to the internal heating of the device 100 of at least one of the following components: the display 150, the communication interface 130, the power unit 180, the electrical load controller 190, and optionally the processing unit 110.

The method 400 comprises the step 435 of executing the neural network inference engine 112. The neural network inference engine 112 implements a neural network using the predictive model (stored at step 420) for inferring one or more output based on inputs. The inputs comprise the area temperature measurement (received at step 425) and the at least one other measurement related to the device 100 (determined at step 430). The one or more output comprises a metric representative of an air vacuum effect in the device 100 (e.g. in the smart thermostat 100). Step 435 is performed by the neural network inference engine 112 executed by the processing unit 110.

The inputs used by the neural network inference engine 112 may include other parameter(s). Similarly, the one or more output generated by the neural network inference engine 112 may include other inferred data.

In an exemplary implementation, the metric representative of the air vacuum effect in the device 100 is a percentage. A percentage of 0% means that no vacuum effect is occurring, while a percentage of 100% means that a maximum vacuum effect is occurring (the air inside the device 100 has a temperature substantially equal to the temperature of the air outside the device 100 in the area). A person skilled in the art would readily understand that other type(s) of metric(s) may be used for implementing the metric representative of the air vacuum effect in the device 100.

The method 400 comprises the step 440 of determining if an adjustment of the area temperature measurement (received at step 425) needs to be performed based on the metric representative of the air vacuum effect in the device 100 (inferred at step 435). Step 440 is performed by the control module 114 executed by the processing unit 110.

The method 400 comprises the optional step 445 of performing the adjustment of the area temperature measurement. Step 445 is performed by the control module 114 executed by the processing unit 110. Step 445 is performed only when the determination at step 440 is positive (if it is determined than an adjustment needs to be performed).

For example, the metric representative of the air vacuum effect in the device 100 is the previously mentioned percentage. For a percentage of 0% (no vacuum effect), the adjustment determined by the previously mentioned adjustment algorithm (e.g. 2 degrees Celsius) is fully applied to the area temperature measurement. For a percentage of 50% (partial vacuum effect), the adjustment determined by the adjustment algorithm is partially applied (e.g. 50% of the determined adjustment: 1 degree Celsius) to the area temperature measurement. For a percentage of 100% (full vacuum effect), no adjustment is applied to the area temperature measurement.

The implementation of the previously mentioned adjustment algorithm (determining the adjustment of the area temperature measurement) is out of the scope of the present disclosure. As mentioned previously, the adjustment algorithm uses one or more parameter representative of heat generated by component(s) of the device 100 for determining the adjustment.

The following steps 450 to 470 are for illustration purposes only, and illustrate the usage of the area temperature measurement received at step 425 and optionally adjusted at step 445. In particular, steps 455 to 470 illustrate the use case represented in FIG. 1B.

The method 400 comprises the step 450 of displaying the area temperature measurement on the display 150. Step 450 is performed by the control module 114 executed by the processing unit 110.

The method 400 comprises the step 455 of generating a command for controlling the controlled appliance 350. The command is based at least on the area temperature measurement. Step 455 is performed by the control module 114 executed by the processing unit 110. For example, the command uses the area temperature measurement and a target temperature (received from a user via the user interface 140) to generate a command for controlling an electrical heater or a VAV appliance.

The method 400 comprises the step 460 of transmitting the command (generated at step 455) to the controlled appliance 350 via the communication interface 130. Step 460 is performed by the control module 114 executed by the processing unit 110.

The method 400 comprises the step 465 of receiving the command at the controlled appliance 350, via the communication interface of the controlled appliance 350. Step 465 is performed by the processing unit of the controlled appliance 350.

The method 400 comprises the step 470 of applying the command at the controlled appliance 350. Step 470 is performed by the processing unit of the controlled appliance 350. Applying the command consists in controlling one or more actuation module of the controlled appliance 350 based on the received command.

In a particular implementation (not represented in FIGS. 4A and 4B for simplification purposes), the temperature sensing module 160 is also capable of measuring a humidity level in the area (where the device 100 is deployed), and transmitting the measured humidity level to the processing unit 110. The measured humidity level is also influenced by heat generated by components (e.g. processing unit 110, display 150, communication interface 130, power unit 180, electrical load controller, etc.) of the device 100. The method 400 determines if an adjustment of the measured humidity level needs to be performed based on the metric representative of the air vacuum effect in the device 100 (inferred at step 435).

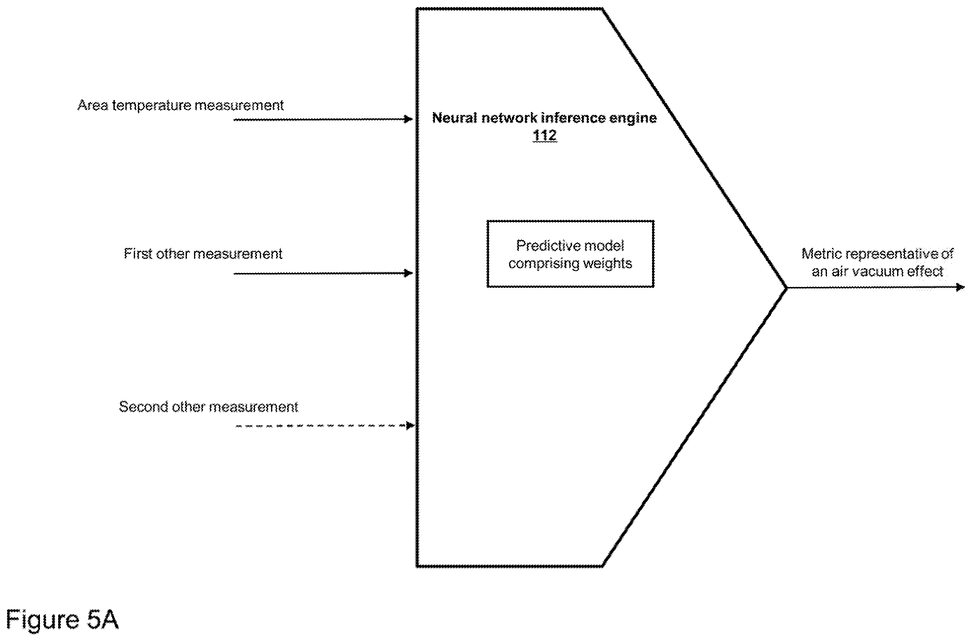

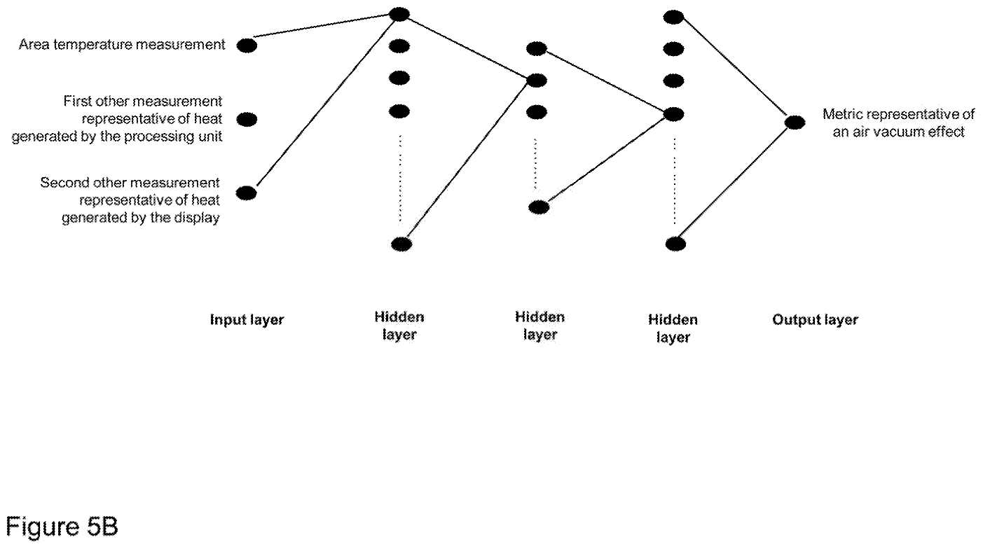

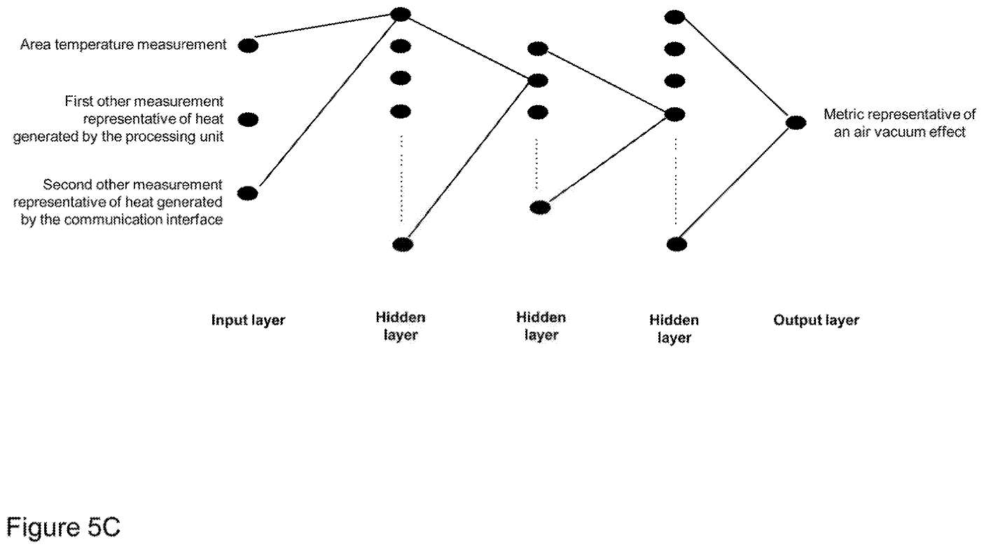

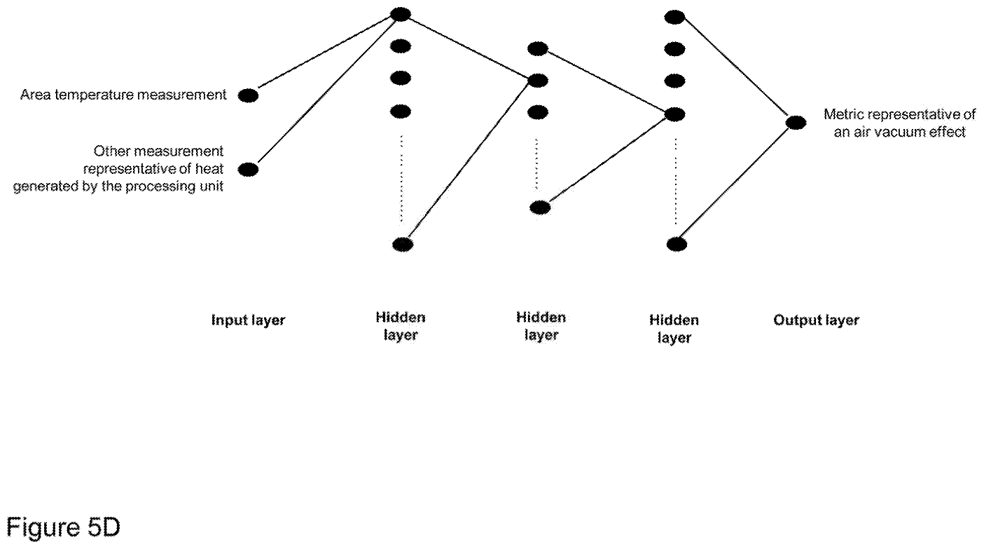

Reference is now made concurrently to FIGS. 4A, 4B, 5A, 5B, 5C and 5D. FIG. 5A illustrates the inputs and the output(s) used by the neural network inference engine 112 when performing step 435. The inputs include the area temperature measurement, and one or more other measurement related to the device 100 (a first other measurement and an optional second other measurement are represented in FIG. 5A for illustration purposes only). The one or more output includes the metric representative of the air vacuum effect.

In a first exemplary implementation illustrated in FIG. 5B, the neural network inference engine 112 implements a neural network comprising an input layer, followed by one or more intermediate hidden layer, followed by an output layer, where the hidden layers are fully connected. The input layer comprises one neuron for receiving the area temperature measurement, one neuron for receiving a first other measurement representative of the heat generated by the processing unit 110, and one neuron for receiving a second other measurement representative of the heat generated by the display 150. The output layer comprises at least one neuron outputting the metric representative of the air vacuum effect.

A layer L being fully connected means that each neuron of layer L receives inputs from every neurons of layer L-1 and applies respective weights to the received inputs. By default, the output layer is fully connected to the last hidden layer.

The generation of the outputs based on the inputs using weights allocated to the neurons of the neural network is well known in the art for a neural network using only fully connected hidden layers. The architecture of the neural network, where each neuron of a layer (except for the first layer) is connected to all the neurons of the previous layer is also well known in the art.

In a second exemplary implementation illustrated in FIG. 5C, the neural network inference engine 112 implements a neural network similar to the one illustrated in FIG. 5B, except for the input layer. The input layer comprises one neuron for receiving the area temperature measurement, one neuron for receiving a first other measurement representative of the heat generated by the processing unit 110, and one neuron for receiving a second other measurement representative of the heat generated by the communication interface 130.

In a third exemplary implementation illustrated in FIG. 5D, the neural network inference engine 112 implements a neural network similar to the one illustrated in FIG. 5B, except for the input layer. The input layer comprises one neuron for receiving the area temperature measurement and one neuron for receiving a single other measurement representative of the heat generated by the processing unit 110.

The implementations illustrated in FIGS. 5B, 5C and 5D are for illustration purposes only. Other combinations of input parameters received by the input layer of the neural network may be used, as was previously mentioned in relation to step 430 of the method 400. Additionally, the neural network is not limited to the architectures illustrated in FIGS. 5B, 5C and 5D, and other types of neural networks may be used.

At least one other measurement related to the device 100 is used as input of the neural network (two in FIGS. 5B and 5C, one in FIG. 5D), according to the method 400 represented in FIGS. 4A and 4B. Using a greater number of other measurements related to the device (e.g. 2 instead of 1, 3 instead of 2, etc.) may improve the accuracy and resiliency of the inferences performed by the neural network inference engine 112 (at the cost of complexifying the predictive models used by the neural network inference engine 112). The relevance of using particular inputs for the neural network is generally evaluated during the training phase, when the predictive model is generated (and tested) with a set of training (and testing) inputs and outputs dedicated to the training (and testing) phase.

Referring back to FIGS. 1A, 1B and 4A, the training phase performed by the neural network training engine 211 of the training server 200 (when performing step 405 of the method 400) is well known in the art. The inputs and output(s) of the neural network training engine 211 are the same as those previously described for the neural network inference engine 112. The training phase consists in generating the predictive model that is used during the operational phase by the neural network inference engine 112. The predictive model includes the number of layers, the number of neurons per layer, and the weights associated to the neurons of the fully connected hidden layers. The values of the weights are automatically adjusted during the training phase. Furthermore, during the training phase, the number of layers and the number of neurons per layer can be adjusted to improve the accuracy of the model.

Various techniques well known in the art of neural networks are used for performing (and improving) the generation of the predictive model, such as forward and backward propagation, usage of bias in addition to the weights (bias and weights are generally collectively referred to as weights in the neural network terminology), reinforcement training, etc.

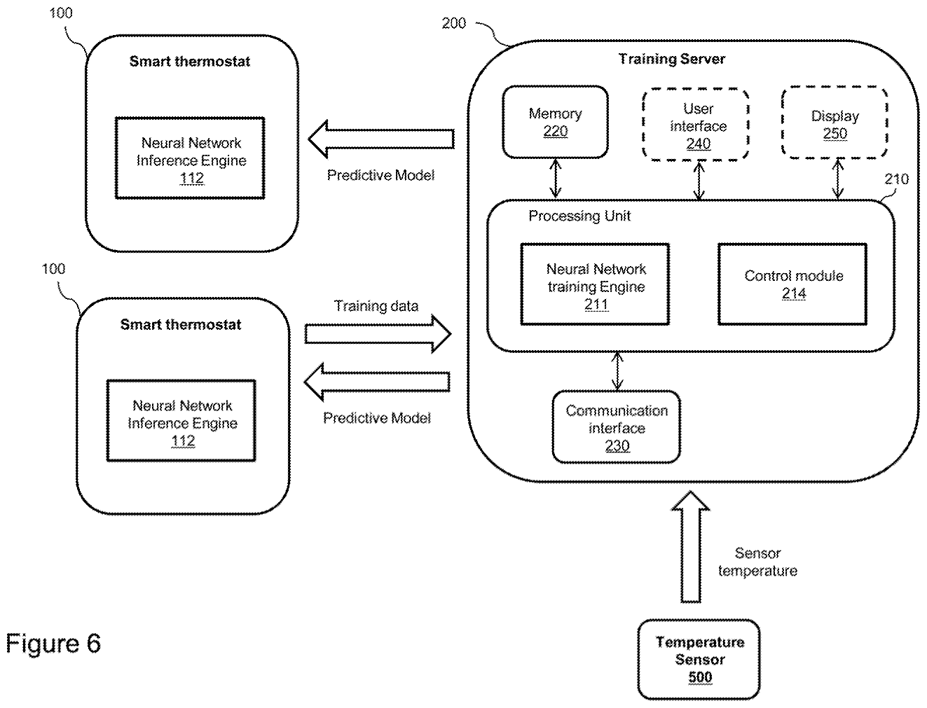

Reference is now made concurrently to FIGS. 1A, 1B, 4A, 4B and 6, where FIG. 6 illustrates the usage of the method 400 in an environment control system comprising several devices 100 (e.g. several smart thermostats).

A plurality of devices 100 implementing the method 400 are deployed at different locations. Only two devices 100 are represented in FIG. 6 for illustration purposes, but any number of devices 100 may be deployed. The different locations may consist of different areas in a given building (e.g. different rooms of the given building on the same of different floors of the given building). The different locations may also be spread across several different buildings.

Each device 100 represented in FIG. 6 corresponds to the device 100 represented in FIGS. 1A and 1B, and executes both the control module 114 and the neural network inference engine 112. Each device 100 receives a predictive model from the centralized training server 200 (e.g. a cloud based training server 200 in communication with the devices 100 via a networking infrastructure, as is well known in the art). The same predictive model is used for all the devices 100. Alternatively, a plurality of predictive models is generated, and takes into account specific characteristics of the devices 100. For example, a first predictive model is generated for devices 100 having a first type of processing unit 110 dissipating a small amount of heat (via the processor(s) of the processing unit 110). A second predictive model is generated for devices 100 having a second type of processing unit 110 dissipating a larger amount of heat (via the processor(s) of the processing unit 110).

Details of the components of the training server 200 are also represented in FIG. 6. The training server 200 comprises a processing unit 210, memory 220, and a communication interface 230. The training server 200 may comprise additional components, such as another communication interface 230, a user interface 240, a display 250, etc.

The characteristics of the processing unit 210 of the training server 200 are similar to the previously described characteristics of the processing unit 110 of the device 100. The processing unit 210 executes the neural network training engine 211 and a control module 214.

The characteristics of the memory 220 of the training server 200 are similar to the previously described characteristics of the memory 120 of the device 100.

The characteristics of the communication interface 230 of the training server 200 are similar to the previously described characteristics of the communication interface 130 of the device 100.

Furthermore, at least some of the devices 100 are adapted for transmitting training data to the training server 200. These training data are used in combination with sensor temperature measurements transmitted by temperature sensor(s) 500 for generating the predictive model during the training phase of the neural network. For each device 100 transmitting training data, a corresponding temperature sensor 500 is deployed in the same area as the device 100, for measuring the real temperature in the area (by contrast to the area temperature measured by the temperature sensing module 160 of the device 100 which is not always accurate as previously described). The temperature sensor 500 transmits the measured real temperature in the area to the training server 200.

Considering a given device 100, an exemplary training phase is as follows (the training phase corresponds to step 405 of the method 400). The given device 100 is subjected to various levels of airflow, to create various levels of air vacuum effect. The neural network is trained to recognize these various levels of air vacuum effect, based on several parameters used as inputs of the neural network. The parameters have been described previously and include: the area temperature measurement received at step 425 of the method 400 and the at least one other measurement determined at step 430 of the method 400. These parameters correspond to the aforementioned training data transmitted by the given device 100 to the training server 200. The given device 100 executes a dedicated training software capable of collecting and transmitting the training data to the training server 200.

The adjusted area temperature measurement (calculated by the processing unit 110 of the given device 100 by applying the adjustment algorithm to the area temperature measurement measured by the temperature sensing module 160 of the given device 100) is also transmitted by the given device 100 to the training server 200. The adjusted area temperature measurement is the estimation of the temperature in the area calculated by the given device 100. For simplification purposes, the adjusted area temperature measurement will be referred to as the estimated area temperature in the following.

The real area temperature measured by the temperature sensor 500 (which is not impacted by the airflow) and the estimated area temperature calculated by the given device 100 (which is impacted by the airflow) are used for quantifying the air vacuum effect.

For example (as mentioned previously), the metric representative of the air vacuum effect is a percentage. The metric is calculated based on a difference between the estimated area temperature and the real area temperature.

When there is no airflow (no vacuum effect), there is no difference between the estimated area temperature and the real area temperature. The metric is set to 0%.

When a maximum airflow is generated by opening a housing of the given device 100 (maximum vacuum effect), the metric is set to 100%. The difference between the estimated area temperature and the real area temperature has a maximum value Max, which is memorized.

Additional airflow conditions are generated, between the condition when there is no airflow and the condition when the airflow is maximum. For each airflow condition, the difference between the estimated area temperature and the real area temperature being D, the metric is equal to D/Max expressed as a percentage. For each airflow condition, the corresponding parameters transmitted by the given device 100 are used as inputs of the neural network and the metric is used as output of the neural network.

In parallel to varying the airflow condition, operating conditions of components of the given device 100 are also varied. The variations are selected so that they have an impact on the parameters used as inputs of the neural network. For example, a CPU utilization of the processor(s) of the processing unit 110 is varied, a power consumption of the display 150 is varied, an amount of data transmitted and/or received by the communication interface 130 is varied, an amount of electrical current transmitted by the electrical load controller 190 is varied, etc.

At the end of the training phase, the predictive model comprising the weights of the neural network is ready. The predictive model is transmitted by the training server 200 to the devices 100, according to step 410 and 415 of the method 400.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A device comprising:
memory for storing a predictive model comprising weights of a neural network;
a temperature sensing module adapted for measuring a temperature of an area where the device is located; and
a processing unit comprising one or more processor configured to:
receive an area temperature measurement from the temperature sensing module;
determine at least one other measurement related to the device; and
execute a neural network inference engine, the neural network inference engine implementing a neural network using the predictive model for inferring one or more output based on inputs, the inputs comprising the area temperature measurement and the at least one other measurement related to the device, the one or more output comprising a metric representative of an air vacuum effect in the device.

2. The device of claim 1, wherein the processing unit further determines if an adjustment of the area temperature measurement needs to be performed based on the metric representative of the air vacuum effect in the device.

3. The device of claim 1, wherein the processing unit includes an integrated temperature sensing module and the at least one other measurement related to the device comprises a temperature measurement of the processing unit performed by the integrated temperature sensing module.

4. The device of claim 1, further comprising at least one other temperature sensing module, each other temperature sensing module performing an internal temperature measurement; and wherein determining at least one other measurement related to the device comprises receiving each internal temperature measurement from the corresponding other temperature sensing module.

5. The device of claim 4, wherein each internal temperature measurement is representative of heat generated by at least one of the following components of the device: a display of the device, a communication interface of the device, the processing unit, a power unit of the device and an electrical load controller of the device.

6. The device of claim 1, wherein the at least one other measurement related to the device comprises a utilization metric of the one or more processor of the processing unit. The device of claim 6, wherein the utilization metric of the one or more processor of the processing unit is calculated based on a Central Processing Unit (CPU) utilization of each of the one or more processor.

8. The device of claim 1, wherein the at least one other measurement related to the device comprises a utilization metric of a display of the device.

9. The device of claim 8, wherein the utilization metric of the display is representative of a dimming level of the display, a light intensity output of the display, a backlight level of the display or an illumination in the area where the device is located, the illumination in the area being measured by an illumination sensor of the device.

10. The device of claim 1, wherein the at least one other measurement related to the device comprises at least one of the following: a utilization metric of a communication interface of the device and a utilization metric of a power unit of the device.

11. The device of claim 1, wherein the neural network inference engine implements a neural network comprising an input layer, followed by fully connected hidden layers, followed by an output layer; the input layer comprising neurons respectively receiving the area temperature measurement and the at least one other measurement related to the device;
the output layer comprising a neuron outputting the metric representative of an air vacuum effect in the device; the weights of the predictive model being applied to the fully connected hidden layers.

12. The device of claim 1, consisting of a smart thermostat.

13. A method using a neural network to detect and compensate an air vacuum effect, the method comprising:
storing a predictive model comprising weights of a neural network in a memory of a device;
receiving by a processing unit of the device an area temperature measurement from a temperature sensing module of the device, the area temperature measurement being representative of a temperature of an area where the device is located;
determining by the processing unit at least one other measurement related to the device; and
executing by the processing unit a neural network inference engine, the neural network inference engine implementing a neural network using the predictive model for inferring one or more output based on inputs, the inputs comprising the area temperature measurement and the at least one other measurement related to the device, the one or more output comprising a metric representative of an air vacuum effect in the device.

14. The method of claim 13, further comprising determining by the processing unit if an adjustment of the area temperature measurement needs to be performed based on the metric representative of the air vacuum effect in the device.

15. The method of claim 13, wherein determining by the processing unit at least one other measurement related to the device comprises determining a temperature measurement of the processing unit performed by an integrated temperature sensing module included in the processing unit.

16. The method of claim 13, wherein determining by the processing unit at least one other measurement related to the device comprises receiving at least one internal temperature measurement, each internal temperature measurement being respectively performed by another temperature sensing module included in the device.

17. The method of claim 16, wherein each internal temperature measurement is representative of heat generated by at least one of the following components of the device: a display of the device, a communication interface of the device, the processing unit, a power unit of the device and an electrical load controller of the device.

18. The method of claim 13, wherein determining by the processing unit at least one other measurement related to the device comprises determining a utilization metric of the one or more processor of the processing unit.

19. The method of claim 18, wherein the utilization metric of the one or more processor of the processing unit is calculated based on a Central Processing Unit (CPU) utilization of each of the one or more processor.

20. The method of claim 13, wherein determining by the processing unit at least one other measurement related to the device comprises determining a utilization metric of a display of the device.

21. The method of claim 20, wherein the utilization metric of the display is representative of a dimming level of the display, a light intensity output of the display, a backlight level of the display or an illumination in the area where the device is located, the illumination in the area being measured by an illumination sensor of the device

22. The method of claim 13, wherein determining by the processing unit at least one other measurement related to the device comprises determining at least one of the following: a utilization metric of a communication interface of the device and a utilization metric of a power unit of the device.

23. The method of claim 13, wherein the neural network inference engine implements a neural network comprising an input layer, followed by fully connected hidden layers, followed by an output layer; the input layer comprising neurons respectively receiving the area temperature measurement and the at least one other measurement related to the device;
the output layer comprising a neuron outputting the metric representative of an air vacuum effect in the device; the weights of the predictive model being applied to the fully connected hidden layers.

24. The method of claim 13, wherein the device consists of a smart thermostat.

25. A non-transitory computer program product comprising instructions executable by a processing unit of a computing device, the execution of the instructions by the processing unit providing for using a neural network to detect and compensate an air vacuum effect by:
storing a predictive model comprising weights of a neural network in a memory of a device;
receiving by a processing unit of the device an area temperature measurement from a temperature sensing module of the device, the area temperature measurement being representative of a temperature of an area where the device is located;
determining by the processing unit at least one other measurement related to the device; and
executing by the processing unit a neural network inference engine, the neural network inference engine implementing a neural network using the predictive model for inferring one or more output based on inputs, the inputs comprising the area temperature measurement and the at least one other measurement related to the device, the one or more output comprising a metric representative of an air vacuum effect in the device.

26. The computer program product of claim 25, the execution of the instructions further provide for determining by the processing unit if an adjustment of the area temperature measurement needs to be performed based on the metric representative of the air vacuum effect in the device.
